(19) United States
(12) Patent Application Publication
(10) Pub. No.: US 2017/0054465 A1
(43) Pub. Date: Feb. 23, 2017

(54) WIRELESS COMMUNICATION NETWORK MANAGEMENT

(71) Applicant: FUJITSU LIMITED, Kawasaki-shi (JP)

(72) Inventors: Milos TESANOVIC, Harrow (GB); Rajni AGARWAL, Ickenham (GB)

(73) Assignee: FUJITSU LIMITED, Kawasaki-shi (JP)

(21) Appl. No.: 15/347,003

(22) Filed: Nov. 9, 2016

Related U.S. Application Data
(63) Continuation of application No. PCT/EP2014/072810, filed on Oct. 24, 2014.

(30) Foreign Application Priority Data
May 13, 2014 (EP) 14168168.4

(51) Int. Cl. H04B 1/3827; H04W 72/08; H04W 72/06; H04W 72/04

(52) U.S. Cl. CPC H04B 1/3838; H04W 72/048; H04W 72/085; H04W 72/06; H04W 36/22

(57) ABSTRACT

In a wireless communication network management method for managing network connectivity of user equipments connected to a first wireless communication network, a decision is made as to whether to change a distribution of user equipments across connectivity paths in the first wireless communication network, when it is desired to effect a change in, or to maintain, a value of a measure of electromagnetic field (EMF) exposure experienced by a population of equipment users as a result of the first wireless communication network. Adverse effects on the network, or other networks to which the UEs have access, which would result from changing the distribution of UEs across connectivity paths in the network, can be avoided using a network management method embodying the present invention. For example, the impact of redistribution on load, signalling overhead, etc. in the network(s) can be taken into consideration.

### CROSS REFERENCES TO RELATED APPLICATIONS

This application is a continuation application of International Patent Application No. PCT/EP2014/072810, filed Oct. 24, 2014, and claims priority to European Patent Application No. EP14168168.4 filed May 13, 2014 the contents of each are herein wholly incorporated by reference.

Embodiments of the present invention relate to wireless communication network management.

While according to the World Health Organization no adverse health effects of radio frequency electromagnetic fields (RF-EMF) have been established to date, EMF exposure from wireless communication networks is nonetheless often cited as a major cause of public concern and is frequently given considerable media coverage. Consequently EMF-aware networking is of interest to network providers.

There is a considerable amount of research and standardisation on defining and enforcing EMF safety limits. Current standards and metrics are built to either specifically measure the compliance of a given device or to evaluate the exposure at a specific location in a given system, which operates at a maximum power level. Additionally, current metrics do not take user quality-of-service (QoS) into account, including various ways in which EMF levels could be reduced while maintaining the required QoS.

Although various approaches to limiting EMF exposure due to mobile devices have been proposed, the focus is on actions performed by the UE leading to a reduction in individual exposure, rather than on actions which take an overall view of the system. In particular, current network management techniques do not take into account EMF exposure, neither via EMF key performance indicators (KPIs) nor via EMF “alarms”.

According to an embodiment of a first aspect of the present invention there is provided a wireless communication network management method for managing network connectivity of user equipments connected to a first wireless communication network, which method comprises making a decision as to whether to change a distribution of user equipments across connectivity paths in the first wireless communication network, when it is desired to effect a change in, or to maintain, a value of a measure of electromagnetic field exposure experienced by a population of equipment users as a result of the first wireless communication network.

Population exposure (PE) for equipment users comprises two EMF components. The first component is fixed and caused by any number of sources external to the network over which network providers have no control (hereafter “EMF noise floor”), whereas the second component is variable and is caused by all the elements within the network under consideration, including base-stations and access-points, as well as UEs.

Adverse effects on the network, or other networks to which the UEs have access, which would result from changing the distribution of UEs across connectivity paths in the network, can be avoided using a network management method embodying the present invention. For example, the impact of redistribution on load, signalling overhead, etc. in the network(s) can be taken into consideration.

In the context of the present application, connectivity paths, which are dependent upon a set of (potentially very complex) parameters, comprise for example:
(a) Networks (RATs) a UE can connect to (e.g. WiFi/2G/3G/4G);
(b) Cells/layers a UE sees within a RAT (e.g. macro/femto);
(c) Connectivity paths available to a UE within a RAT based e.g. on MIMO/CoMP, or the availability of relaying/D2D features;
(d) A combination of two or more of (a), (b) and (c).

Each connectivity path has an associated EMF exposure impact on equipment users, which can differ from path to path.

The decision to change the distribution of UEs may be made in dependence upon one or more of: (i) a number of connectivity paths, in the first wireless communication network or one or more other wireless communication networks, available to the user equipments; (ii) the current value of the EMF exposure measure determined for the population of equipment users; (iii) geographical proximity of the user equipments to each other; (iv) the current value of an individual EMF exposure measure of one or more equipment users; (v) a change, or predicted change, in the EMF exposure measure, (vi) one or more performance criteria of the first communication network, (vii) changes in the distribution of user equipments across connectivity paths in the first wireless communication network or one or more other wireless communication networks; and (viii) changes in the population of equipment users.

In the context of the present application, performance criteria include (but are not limited to) channel conditions, QoS and SINR (signal-to-noise ratio).

A method embodying the first aspect of the invention may further comprise, when the decision is to change the distribution of user equipments, changing the distribution so as to tend to return the value of the EMF exposure measure of the population to a reference value of the EMF exposure measure which is commensurate with a quality of service metric of the user equipments having at least a predetermined value.

When the decision is to change the distribution of user equipments, in a method embodying the first aspect of the invention the distribution may be changed by: (i) transferring at least one of the user equipments from a connectivity path in the first communication network to a connectivity path in a second wireless communication network available to that user equipment, and/or (ii) transferring at least one of the user equipments from a first connectivity path in the first communication network to a second, different, connectivity path in the first communication network. Connectivity paths in the first or each wireless communication network available to the user equipments may be ranked in accordance with a ranking factor, and changing the distribution may comprise transferring at least one of the user equipments to the highest-ranked available connectivity path. For example, the ranking factor of each connectivity path may be dependent upon the anticipated effect of transferring user equipment to the connectivity path concerned on one or more of: (i) the value of the EMF exposure measure for the population of equipment users which would remain in the first wireless communication network after the transfer; (ii) one or more performance criteria of the first wireless communication network; and (iii) the value of an individual EMF exposure measure for the user of the equipment.

In a preferred method embodying the present invention, at least some of the user equipments are considered as a group for the purpose of making the decision. In this case the method may further comprise allocating the user equipments to one or more groups, ranking each of the resulting groups and identifying the highest-ranked group, and collectively changing the distribution across the connectivity paths of all the user equipments in the highest-ranked group. For example user equipments may be allocated to groups according to one or more of: (i) the number and/or type of connectivity paths shared by the group; (ii) the level of EMF exposure contributed by each user equipment in the group; (iii) quality of service requirements shared by the group; and (iv) a shared ability to enable a reduction in signalling overhead upon transfer of the user equipment to another connectivity path.

According to a wireless communication network management method embodying the an aspect of the present invention, for managing network connectivity of user equipments connected to a first wireless communication network, a distribution of user equipments across connectivity paths in the first wireless communication network may be changed based on a measure of EMF exposure experienced by a population of equipment users as a result of the first wireless communication network.

According to an embodiment of a second aspect of the present invention there is provided a wireless communication network management system for managing network connectivity of user equipments connected to a first wireless communication network, which system comprises apparatus configured to make a decision as to whether to change a distribution of user equipments across connectivity paths in the first wireless communication network, when it is desired to effect a change in, or to maintain, a value of a measure of electromagnetic field (EMF) exposure experienced by a population of equipment users as a result of the first wireless communication network.

The apparatus may be operable to make the decision in dependence upon one or more of: (i) a number of connectivity paths, in the first wireless communication network or one or more other wireless communication networks, available to the user equipments; (ii) the current value of the EMF exposure measure determined for the population of equipment users; (iii) geographical proximity of the user equipments to each other; (iv) the current value of an individual EMF exposure measure of one or more equipment users; (v) a change, or predicted change, in the EMF exposure measure, (vi) one or more performance criteria of the first communication network, (vii) changes in the distribution of user equipments across connectivity paths in the first wireless communication network or one or more other wireless communication networks; and (viii) changes in the population of equipment users.

When the decision is to change the distribution of user equipments, the system may be operable to change the distribution so as to tend to return the value of the EMF exposure measure of the population to a reference value of the EMF exposure measure which is commensurate with a quality of service metric of the user equipments having at least a predetermined value.

A system embodying the second aspect of the present invention may further comprise control means operable, when the decision is to change the distribution of user equipments, to change the distribution by bringing about (i) transfer of at least one of the user equipments from a connectivity path in the first communication network to a connectivity path in a second wireless communication network available to that user equipment, and/or (ii) transfer of at least one of the user equipments from a first connectivity path in the first communication network to a second, different, connectivity path in the first communication network. Connectivity paths in the first or each wireless communication network available to the user equipments may be ranked in accordance with a ranking factor, and the control means are operable to bring about transfer of at least one of the user equipments to the highest-ranked available connectivity path. The ranking factor of each connectivity path may be dependent upon the anticipated effect of transferring user equipment to the connectivity path concerned on one or more of: (i) the value of the EMF exposure measure for the population of equipment users which would remain in the first wireless communication network after the transfer; (ii) one or more performance criteria of the first wireless communication network; and (iii) the value of an individual EMF exposure measure for the user of the equipment.

In a system embodying the second aspect of the present invention, the apparatus may be operable to consider at least some of the user equipments as a group for the purpose of making the decision. In this case the apparatus may be operable to allocate the user equipments to one or more groups, rank each of the resulting groups and identify the highest-ranked group, and collectively change the distribution across the connectivity paths of all the user equipments in the highest-ranked group. User equipments may be allocated to groups according to one or more of: (i) the number and/or type of connectivity paths shared by the group; (ii) the level of EMF exposure contributed by each user equipment in the group; (iii) quality of service requirements shared by the group; and (iv) a shared ability to enable a reduction in signalling overhead upon transfer of the user equipment to another connectivity path.

According to an embodiment of a third aspect of the present invention there is provided a computer program which, when run on a computer, causes that computer to carry out a method embodying the first aspect of the present invention.

In one embodiment the EMF exposure measure is the weighted sum of the SARs, where the weighting is done based on user characteristics and/or morphologies and/or preferences with regard to EMF exposure, but is not limited to this.

Reference will now be made, by way of example, to the accompanying drawings, in which:

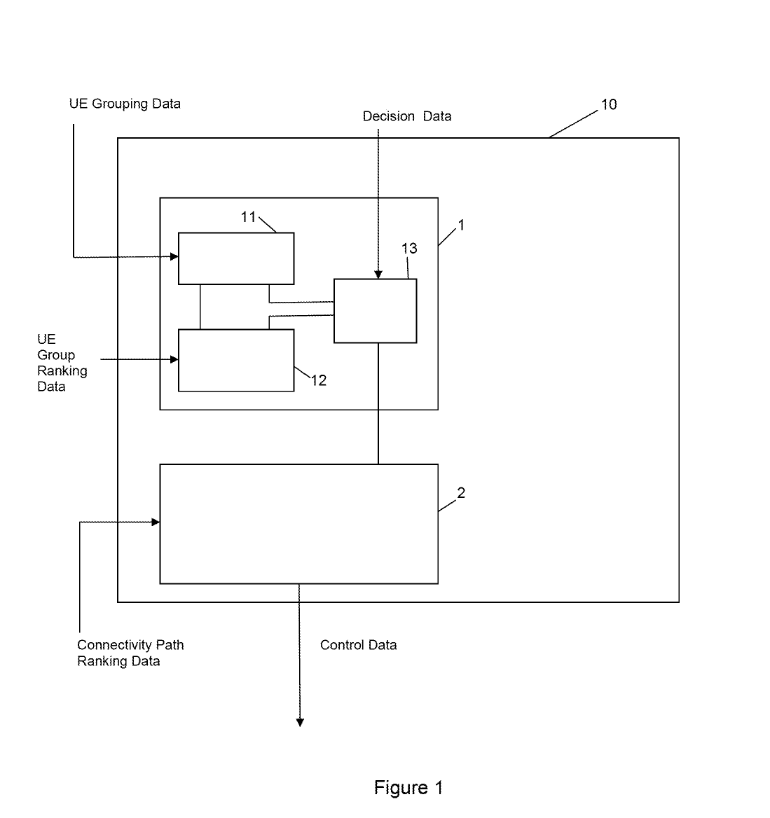

FIG. 1 shows a network management system embodying the second aspect of the present invention; and

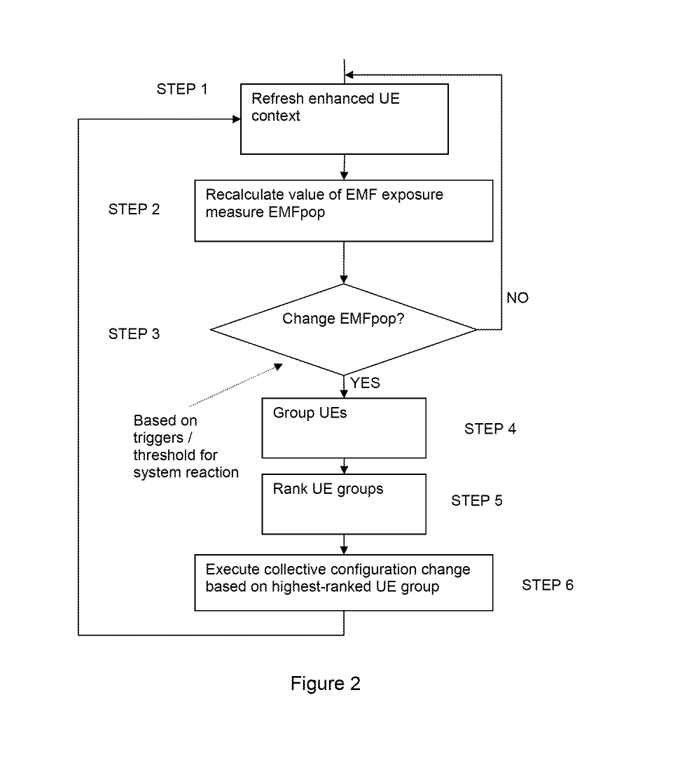

FIG. 2 is a flowchart of a method embodying the first aspect of the present invention.

The present invention utilises the fact that, in most urban and sub-urban areas, the wireless environment is multi-RAT (multi-Radio Access Technology), meaning that to most UEs at least two wireless connectivity paths are available.

In an aspect of the invention a decision is made as to whether to change a distribution of user equipments across connectivity paths in a wireless communication network, when it is desired to effect a change in, or to maintain, a value of a measure of EMF exposure experienced by a population of equipment users as a result of the wireless communication network.

A directed change in the value of an EMF exposure measure of a population of equipment users may be desirable in a number of different circumstances. The value of the measure may have increased up to or beyond, or decreased below, a preset level, or have changed by more than a preset percentage over the last value calculated for the measure. Similarly, action to maintain a value of the EMF exposure measure may be taken if an undesirable change in the value of the measure is anticipated, owing to expected changes in one or more factors affecting it. A value for the EMF exposure measure for a population of equipment users can be determined, at regular or irregular intervals, for example by summing the estimated (or actual measured) EMF exposure resulting from each UE and that from other elements in the network. In this respect it can be helpful to pre-assign each UE (and hence its user) a predefined EMF exposure class indicating the level of EMF exposure experienced by a user of that UE based on the connectivity path employed by the UE. In its most simple form there may be just two classes, for example, denoting “low” and “higher” EMF exposure. The determined value of the EMF exposure measure for the population can be compared to a reference value for the measure.

For example, when the decision is to change the distribution of user equipments, the distribution may be changed so as to tend to return the value of the EMF exposure measure of the population to a reference value of the EMF exposure measure which is commensurate with a quality of service metric of the user equipments having at least a predetermined value.

In this regard, it is assumed that the system has an “equilibrium state” where the exposure is minimised for given QoS. The “equilibrium state” may be defined in terms of population exposure for a given environment, such as urban outdoor, indoor campus, rural, etc, at a given time, such as morning/afternoon/night.

Since, as mentioned above, different connectivity paths may have different EMF exposure impacts, changing the distribution of the UEs across the connectivity paths in the network will result in a change in the value of the EMF exposure measure of the population of equipment users as a result of the network. In the present invention the advantage of changing the distribution of UEs across the available connectivity paths, in order to change or maintain a value of the EMF exposure measure, is weighed against other factors to minimise or avoid unnecessary or undesirable effects on the or another network.

For example, the decision to change the distribution of UEs across connectivity paths in the network may be dependent upon one or more items of decision data comprising, for example: (i) a number of connectivity paths, in the first wireless communication network or one or more other wireless communication networks, available to the user equipments; (ii) the current value of the EMF exposure measure determined for the population of equipment users; (iii) geographical proximity of the user equipments to each other; (iv) the current value of an individual EMF exposure measure of one or more equipment users; (v) a change, or a predicted change, in the EMF exposure measure, (vi) one or more performance criteria of the first communication network, (vii) changes in the distribution of user equipments across connectivity paths in the first wireless communication network or one or more other wireless communication networks; and (vii) changes in the population of equipment users.

For example, it might be that action is taken to try to reduce the EMF exposure of those users whose EMF exposure has increased but is still relatively low, if the number of available connectivity paths is high. This would ensure that any “disturbance” to the system (e.g. signalling involved with the handover) is spread out, since UEs would be redistributed across different connectivity paths (in a targeted or possibly random manner).

In another example, if the number of available connectivity paths is comparatively low (for example, if there is only one alternative, say from 3G to 2G), then a redistribution of

UEs will not be performed by default, perhaps only if the number of users affected is high enough so as to reduce the population exposure by a certain predefined percentage, or if QoS could not be preserved otherwise. This ensures that the number of users switched onto the same connectivity path is not such that the connectivity path is overloaded, unless a certain “necessity” criterion is satisfied.

In another example, a decision to redistribute UEs across the connectivity paths could be taken if, based on geographical proximity of UEs, it were advantageous (for example, because of reduced signalling overhead) to offload a group of users, for example from a single macro eNB to a single WiFi AP.

Grouping of UEs for vertical handover can be advantageous. Conventionally, vertical handover exploits a multi-RAT environment to locally select the best access technology for a given UE, typical optimization parameters being the user spectral efficiency, load balancing, and energy saving.

In an aspect of the invention at least some of the user equipments are considered as a group for the purpose of making a decision as to whether to change the distribution of UEs across the available connectivity paths. This may be done, for example, by allocating the user equipments to one or more groups, ranking each of the resulting groups on the basis of group ranking data and identifying the highest-ranked group, and collectively changing the distribution across the connectivity paths of all the user equipments in the highest-ranked group.

By way of example, and without limitation, UEs may be grouped according to one or more items of grouping data comprising: (i) the number and/or type of connectivity paths shared by the group; (ii) the level of EMF exposure contributed by each user equipment in the group; (iii) quality of service or other performance requirements shared by the group; and (iv) a shared ability to enable a reduction in signalling overhead upon transfer of the user equipment to another connectivity path (e.g. a shared ability to broadcast a message to switch to another wireless communication network).

In an embodiment of this aspect the grouping of users is done based on one or more of:
a. Common number & type of “degrees of freedom” shared by the group
b. Comparable level of EMF exposure contributed by members of the group
c. Ability to broadcast “switch RAT” messages
d. Common QoS requirements

In an aspect of the present invention the distribution of UEs across connectivity paths in the first wireless communication network is changed in order to effect a change in a measure of EMF exposure experienced by a population of equipment users as a result of the first wireless communication network. Changing the distribution may comprise one or more of: (i) transferring at least one of the user equipments from a connectivity path in the first communication network to a connectivity path in a second wireless communication network available to that user equipment; and (ii) transferring at least one of the user equipments from a first connectivity path in the first communication network to a second, different, connectivity path in the first communication network.

Connectivity paths in the first or each wireless communication network available to the UEs may be ranked in accordance with a ranking factor. In this case, changing the distribution may comprise transferring at least one of the user equipments to the highest-ranked available connectivity path.

The ranking factor of each connectivity path may be dependent upon the anticipated effect of transferring user equipment to the connectivity path concerned on one or more of: (i) the value of the EMF exposure measure for the population of equipment users which would remain in the first wireless communication network after the transfer; (ii) one or more performance criteria of the first wireless communication network; and (iii) the value of an individual EMF exposure measure for the user of the equipment.

For example, in one embodiment the ranking factor is dependent upon one or more of:
a. the power level of each connectivity path (e.g. WiFi<4G<3G<2G)
b. the specific radio frequency, and/or whether the user is indoor/outdoor
c. the signalling load required for potential switching
d. the ease of grouping users for group handover
e. the number of connectivity paths available to a UE (WiFi/2G/3G/4G; cells/layers the UE sees within a RAT; number of paths available based on MIMO/CoMP)
f. the geographical proximity of UEs reporting an EMF exposure measure increase (for possible switching to D2D mode)
g. the pair {number of connectivity paths, EMF class}

An embodiment of this aspect of the invention employs specific ordering of connectivity paths/RATs in terms of their EMF impact as well as potential “disturbance” to system (embodied in such parameters as signalling load required for potential switching, the ease of grouping users for group vertical handover, and so on) in order to select a connectivity path/RAT which will achieve the greatest change in the value of the EMF exposure measure for the population. For example, each available mechanism that would help alleviate EMF exposure, or restore the system to its previous “equilibrium state”, may be ranked, where for a given user distribution in an area and their data traffic the minimum possible population exposure is achieved.

Embodiments of the present invention may enable network management strategies which achieve a reduction in population exposure based on varying users' distributions across various RATs (Radio Access Technologies) in an area. More specifically, with a view to reducing the population exposure, network/radio link configurations of UEs in a network may be changed in response to changes in the network, for example changes in the distribution and/or type of users across various types of connectivity paths (such as wideband/WiFi, home/office, on the move/stationary users) and/or changes in “individual” EMF exposure, e.g. which exposure “class” a user belongs to compared to where he or she was before.

A wireless communication network management system 10, for managing network connectivity of user equipments connected to a first wireless communication network, which embodies the second aspect of the present invention is shown in FIG. 1. The system 10 comprises decision apparatus 1 which includes a decision unit 13 configured to make a decision as to whether to change a distribution of user equipments across connectivity paths in the first wireless communication network, when it is desired to effect a change in, or to maintain, a value of a measure of electromagnetic field (EMF) exposure experienced by a population of equipment users as a result of the first wireless communication network.

The decision unit 13 receives decision data in dependence upon which it is operable to make the decision. For example, the decision data may comprise one or more of: (i) a number of connectivity paths, in the first wireless communication network or one or more other wireless communication networks, available to the user equipments; (ii) the current value of the EMF exposure measure determined for the population of equipment users; (iii) geographical proximity of the user equipments to each other; (iv) the current value of an individual EMF exposure measure of one or more equipment users; (v) a change, or predicted change, in the EMF exposure measure, (vi) one or more performance criteria of the first communication network, (vii) changes in the distribution of user equipments across connectivity paths in the first wireless communication network or one or more other wireless communication networks; and (viii) changes in the population of equipment users.

The system 10 further comprises control means 4. The control means 4 are operable, when the decision of the decision unit 1 is to change the distribution of user equipments, to change the distribution by bringing about (i) transfer of at least one of the user equipments from a connectivity path in the first communication network to a connectivity path in a second wireless communication network available to that user equipment, and/or (ii) transfer of at least one of the user equipments from a first connectivity path in the first communication network to a second, different, connectivity path in the first communication network. The control means 4 receive connectivity path ranking data on the basis of which connectivity paths in the first or each wireless communication network available to the user equipments are ranked in accordance with a ranking factor. The control means 4 are operable to bring about transfer of at least one of the user equipments to the highest-ranked available connectivity path. The ranking factor of each connectivity path may be dependent upon the anticipated effect of transferring user equipment to the connectivity path concerned on one or more of: (i) the value of the EMF exposure measure for the population of equipment users which would remain in the first wireless communication network after the transfer; (ii) one or more performance criteria of the first wireless communication network; and (iii) the value of an individual EMF exposure measure for the user of the equipment.

The decision apparatus 1 further comprises a UE grouping unit 11 and a UE group ranking unit 12, whereby the decision apparatus 1 is operable to consider at least some of the user equipments as a group for the purpose of making the decision. The UE grouping unit 11 is operable to allocate the user equipments to one or more groups on the basis of UE grouping data, such as one or more of: (i) the number and/or type of connectivity paths shared by the group; (ii) the level of EMF exposure contributed by each user equipment in the group; (iii) quality of service requirements shared by the group; and (iv) a shared ability to enable a reduction in signalling overhead upon transfer of the user equipment to another connectivity path. The UE group ranking unit 12 is operable to rank each of the resulting groups and identify the highest-ranked group. The decision unit 13 is configured to decide to collectively change the distribution across the connectivity paths of all the user equipments in the highest-ranked group.

A method embodying an aspect of the present invention, in which users are grouped and any action taken is done on a group level, will now be described with reference to FIG. 2. Additional/alterative ways of grouping users and actions subsequently performed are envisaged to those described in the following example. Grouping of users is not a feature essential to the invention, but it can be advantageous.

In Step 1 of the method of FIG. 2, an enhanced UE context is refreshed. In an enhanced UE context of this embodiment users of wireless devices (or UEs) are assigned respective EMF exposure levels from a small number of predefined levels (in its simplest form, only two levels, low EMF and “not-so-low”, or higher, EMF). In addition to that, each user has a QoS requirement. Users are also assigned a “number of degrees of freedom” which is the number of connectivity paths available to the UE. This can be the number of different networks a UE can connect to (WiFi/2G/3G/4G), cells/layers the UE sees within a RAT, the number of paths available based on MIMO/CoMP. The number of degrees of freedom can be limited in a further refinement to take account of user preferences regarding the trade-off between reduced EMF exposure vs. QoS requirements.

In the discussions below the following mathematical notation is employed:
1. For each UE within a target area “A” (the target area is determined by external constraints)
   a. Minimum required QoS: QoSₘᵢₙ
   b. Maximum allowed EMF Exposure: EMFₘₐₓ
   c. Number of degrees of freedom: n
   d. Types of connectivity (degrees of freedom): C={c₁, c₂, cₙ}where for example: c₁=3G, c₂=WiFi @2.4G, c₃=WiFi @5G and so on The values of “C” and “n” for any UE can vary as a function of time and UE location.
   e. UE Preference: P; in its simplest form, it may be a Boolean parameter where P=true implies that QoS trade-off in favour of lower EMF is acceptable.
2. For the target area “A”
   a. Exhaustive set of UEs with active connection: UEactive={UE₁, UE₂, . . . UEₘ}
   b. EMF exposure contributed by an active UE on a certain connectivity type:
   c. Population EMF Exposure: EMFpop; this refers to only that component of total EMF exposure which is caused by the network under consideration EMFpop=EMF_{nw}+EMF_{UE1}+EMF_{UE2}++EMF_{UEm} where EMF_{nw}denotes the EMF caused by the network in its idle state
   d. Number of degrees of freedom for all or a sub-set of active UEs: n_{group} This parameter is explained in further detail under “Grouping of UEs”

The triggers and threshold for redistribution of UEs across connectivity paths in a network according to an embodiment of the invention will now be described.

If the Population Exposure of a population of equipment users in a target area “A” at a state of equilibrium is denoted by EMF_{equi}, then a threshold EMFₜₕᵣₑₛ is set such that at any given time, the condition must be satisfied:

EMFₚₒₚ≦EMF_{equi}+EMFₜₕᵣₑₛ

The value of EMFₜₕᵣₑₛ may depend on a number of parameters that include but are not limited to:
vulnerability to EMF exposure of the population in target area “A”
network operator's compliance targets
value of the EMF noise floor in the target area A

Additionally, the parameters may be ranked using a weighting factor.

A step-size EMFₛₜₑₚ, which denotes a level increase in EMFₚₒₚ that should trigger consideration of UE redistribution, is also set. The value of EMFₛₜₑₚ depends on parameters such as:
number of degrees of freedom (e.g. the higher the number, the smaller the step-size)
vulnerability to EMF exposure of target population (e.g. smaller step-size in areas such as schools, hospitals, etc.)
EMF measurement capabilities of the system (if EMF estimates are unreliable, then there is no point in having too fine a reaction threshold; on the other hand, in the case of a tuneable measuring capability, finer quantization of measurements can be used, e.g. if the population is EMF-sensitive, or if regulations change)
individual user preferences

Step 2 of the method of FIG. 2 comprises recalculating a value for the EMF exposure measure EMFpop. In an embodiment of the present invention EMFpop is monitored at regular, predefined intervals tᵢₙₜ. The value of tᵢₙₜ may remain constant or change, for example at different times of the day (for example, tᵢₙₜ=120 sec between 0700-1100; 600 sec between 1100-1700; 60 sec between 1700-2000 and so on) or days in the year.

In Step 3 of the method of FIG. 2 a decision is made as to whether it is desirable to effect a change in the value of EMFpop. If it is considered necessary to effect a change in the value of EMFpop, for example if EMFpop−EMF_{equi}(=ΔEMF)>EMFₛₜₑₚ, then the following Steps 4,5 and 6 are carried out:

Step 4. Grouping of UEs
Due to individual “n” & “C” property values for each of the active UEs, the value of “n” & “C” as applied to the entire group may be different. For example, consider a set of active UEs {UE1, UE2, UE3}.
Further assume corresponding degrees of freedom—

n_{UE1}=4, C_{UE1}={c₀, c₁, c₂, c₃};

n_{UE2}=3, C_{UE2}={c₁, c₂, c₃};

n_{UE3}=3, C_{UE3}={c₂, c₃, c₄};
Then, grouping may be performed in a number of combinations as follows with consequent degrees of freedom of the group:

G₁={UE₁, UE₂, UE₃, }, n_{G1}=2, C_{G1}={c₂, c₃};

G₂={UE₁, UE₂}, n_{G2}=3, C_{G2}={c₁, c₂, c₃};

G₃={UE₂}, n_{G3}=3, C_{G3}={c₂, c₃, c₄};

Step 5. Ranking of Groups
The system analyses the merit of all potential combinations based on the combined impact on QoS and EMFₚₒₚ.
The factors that impact QoS include, among others:
Availability of scheduling resources especially in a target state of configuration
Service in use by active UEs
Signal strength at the UE for various configurations corresponding to available connectivity paths
The factors that impact EMFₚₒₚ include, among others:
Total number of state transitions, which in turn is a function of size of group
EMF contributed by each of the available connectivity paths

A ranking is applied taking into account all the above factors and a group (the highest-ranked group) is chosen for next step.

Step 6. Change distribution of UEs based on Grouping
If there are one or more non-empty Groups from the previous two steps, then—
1. A collective change of configuration is executed for the highest ranked group of UEs through a reconfiguration process supported by the RAT technology of operation.
2. Further, if any of the lower ranked Groups comprise active UEs that were not part of the highest ranked Group, i.e. a “disjoint” set, then a collective change of configuration is executed for all UEs within such a group. This process may repeat iteratively for all groups. Since the step-size depends on the number of degrees of freedom “n”, EMFₛₜₑₚ may be iteratively refined during the grouping process.
If there are no non-empty Groups from the previous two steps 4 and 5, then it is assumed that there are no feasible options available for a transition that would allow lower EMF exposure while maintaining the QoS requirements.

The above embodiment has been described using QoS as an example, but the decision could be taken using one or more other performance criteria, or non- performance related criteria, as a factor.

The EMF-aware network management mechanisms described in the present application allow network operators to incorporate EMF exposure as one of their KPIs. New services could be offered to network operators, including: the implementation of a low-EMF, QoS-aware Network Management Service embodying the invention, and the implementation of a cloud Connection Manager, which could in some embodiments bypass the operator's network to implement user preferences.

Embodiments of the present invention may be implemented in hardware, or as software modules running on one or more processors, or on a combination thereof. That is, those skilled in the art will appreciate that a microprocessor or digital signal processor (DSP) may be used in practice to implement some or all of the functionality described above.

The invention may also be embodied as one or more device or apparatus programs (e.g. computer programs and computer program products) for carrying out part or all of the methods described herein. Such programs embodying the present invention may be stored on computer-readable media, or could, for example, be in the form of one or more signals. Such signals may be data signals downloadable from an Internet website, or provided on a carrier signal, or in any other form.

What is claimed is:

1. A wireless communication network management method for managing network connectivity of user equipments connected to a first wireless communication network, which method comprises making a decision as to whether to change a distribution of user equipments across connectivity paths in the first wireless communication network, when it is desired to effect a change in, or to maintain, a value of a measure of electromagnetic field (EMF) exposure experienced by a population of equipment users as a result of the first wireless communication network.

2. A method as claimed in claim 1, wherein the decision made is dependent upon one or more of: (i) a number of connectivity paths, in the first wireless communication network or one or more other wireless communication networks, available to the user equipments; (ii) the current value of the EMF exposure measure determined for the population of equipment users; (iii) geographical proximity of the user equipments to each other; (iv) the current value of an individual EMF exposure measure of one or more equipment users; (v) a change, or predicted change, in the EMF exposure measure, (vi) one or more performance criteria of the first communication network, (vii) changes in the distribution of user equipments across connectivity paths in the first wireless communication network or one or more other wireless communication networks; and (viii) changes in the population of equipment users.

3. A method as claimed in claim 1, further comprising, when the decision is to change the distribution of user equipments, changing the distribution so as to tend to return the value of the EMF exposure measure of the population to a reference value of the EMF exposure measure which is commensurate with a quality of service metric of the user equipments having at least a predetermined value.

4. A method as claimed in claim 1, further comprising, when the decision is to change the distribution of user equipments, changing the distribution by: (i) transferring at least one of the user equipments from a connectivity path in the first communication network to a connectivity path in a second wireless communication network available to that user equipment, and/or (ii) transferring at least one of the user equipments from a first connectivity path in the first communication network to a second, different, connectivity path in the first communication network.

5. A method as claimed in claim 4, wherein connectivity paths in the first or each wireless communication network available to the user equipments are ranked in accordance with a ranking factor, and changing the distribution comprises transferring at least one of the user equipments to the highest-ranked available connectivity path.

6. A method as claimed in claim 5, wherein the ranking factor of each connectivity path is dependent upon the anticipated effect of transferring user equipment to the connectivity path concerned on one or more of: (i) the value of the EMF exposure measure for the population of equipment users which would remain in the first wireless communication network after the transfer; (ii) one or more performance criteria of the first wireless communication network; and (iii) the value of an individual EMF exposure measure for the user of the equipment.

7. A method as claimed in claim 1, wherein at least some of the user equipments are considered as a group for the purpose of making the decision.

8. A method as claimed in claim 7, comprising allocating the user equipments to one or more groups, ranking each of the resulting groups and identifying the highest-ranked group, and collectively changing the distribution across the connectivity paths of all the user equipments in the highest-ranked group.

9. A method as claimed in claim 7, wherein user equipments are allocated to groups according to one or more of: (i) the number and/or type of connectivity paths shared by the group; (ii) the level of EMF exposure contributed by each user equipment in the group; (iii) quality of service requirements shared by the group; and (iv) a shared ability to enable a reduction in signalling overhead upon transfer of the user equipment to another connectivity path.

10. A wireless communication network management system for managing network connectivity of user equipments connected to a first wireless communication network, which system comprises apparatus configured to make a decision as to whether to change a distribution of user equipments across connectivity paths in the first wireless communication network, when it is desired to effect a change in, or to maintain, a value of a measure of electromagnetic field (EMF) exposure experienced by a population of equipment users as a result of the first wireless communication network.

11. A system as claimed in claim 10, wherein the system is operable to make the decision in dependence upon one or more of: (i) a number of connectivity paths, in the first wireless communication network or one or more other wireless communication networks, available to the user equipments; (ii) the current value of the EMF exposure measure determined for the population of equipment users; (iii) geographical proximity of the user equipments to each other; (iv) the current value of an individual EMF exposure measure of one or more equipment users; (v) a change, or predicted change, in the EMF exposure measure, (vi) one or more performance criteria of the first communication network, (vii) changes in the distribution of user equipments across connectivity paths in the first wireless communication network or one or more other wireless communication networks; and (viii) changes in the population of equipment users.

12. A system as claimed in claim 10, further comprising control means operable, when the decision is to change the distribution of user equipments, to change the distribution by bringing about (i) transfer of at least one of the user equipments from a connectivity path in the first communication network to a connectivity path in a second wireless communication network available to that user equipment, and/or (ii) transfer of at least one of the user equipments from a first connectivity path in the first communication network to a second, different, connectivity path in the first communication network.

13. A system as claimed in claim 12, wherein connectivity paths in the first or each wireless communication network available to the user equipments are ranked in accordance with a ranking factor, and the control means are operable to bring about transfer of at least one of the user equipments to the highest-ranked available connectivity path.

14. A system as claimed in claim 10, wherein the apparatus is operable to consider at least some of the user equipments as a group for the purpose of making the decision.

15. A system as claimed in claim 14, comprising allocating the user equipments to one or more groups, ranking each of the resulting groups and identifying the highest-ranked group, and collectively changing the distribution across the connectivity paths of all the user equipments in the highest-ranked group.
